(19) United States
(12) Patent Application Publication
(10) Pub. No.: US 2006/0085249 A1
(43) Pub. Date: Apr. 20, 2006

(54) Method and apparatus for mining patent data

(75) Inventors: Luis J. Diaz, Green Brook, NJ (US); James A. Digiorgio, Green Brook, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/948,122

(22) Filed: Sep. 24, 2004

(51) Int. Cl. H04M 3/51

(52) U.S. Cl. 705/11

(57) ABSTRACT

A system for determining a relative value of at least one patent includes: a database configured to store at least one factor for calculating a Z score for the at least one patent; a database for storing at least one received subjective factor relevant to the at least one patent; a first computer program product configured to calculate a Z score based on the at least one factor; a second computer program product configured to modify the Z score based on the at least one subjective factor, thereby obtaining a modified Z score; and a third computer program product configured to output the modified Z score.

### FIELD OF THE INVENTION

The present invention relates to a method and apparatus for evaluating patents based on statistically significant correlates of strength and value. The present invention enables a more ready comprehension of the relative commercial value of the patent assets being evaluated.

### BACKGROUND OF THE INVENTION

Often, it is difficult for a company seeking to acquire patent assets to properly value these assets. Specifically, it may be necessary or commercially useful to consider factors other than the objective value of the patent. In the past, however, it has been difficult for companies to properly value patent assets they wish to acquire.

### SUMMARY OF THE INVENTION

To this end, the present invention provides a method and apparatus of data mining that ranks related patents based on statistically significant correlates of strength and value. According to a non-limiting embodiment of the present invention, relative value may be established by aggregating the resulting Z score with input objective data related to industry size, relevant product sales, as well as other input that may be obtained from a population of surveyed experts in the relevant field of technology.

According to another non-limiting embodiment of the present invention, the relationship between the various components of the Z score may be expressed based on weighted combinations of several predicates. The user may select portions of the Z score to analyze the underlying data correlates. The user may also interact to control the Z score correlates and to adjust these correlates to focus attention on certain aspects of the Z score that most interest the user. In short, the Z score of the present invention enables more ready comprehension of the relative commercial value of patent assets.

More specifically, the present invention provides, as a non-limiting aspect, a method for determining a relative value of at least one patent, the method including: calculating a Z score for the at least one patent; and modifying the Z score based on at least one subjective factor.

Another non-limiting aspect of the present invention provides a system for determining a relative value of at least one patent, the system including: a database configured to store at least one factor for calculating a Z score for the at least one patent; a database for storing at least one received subjective factor relevant to the at least one patent; a first computer program product configured to calculate a Z score based on the at least one factor; a second computer program product configured to modify the Z score based on the at least one subjective factor, thereby obtaining a modified Z score; and a third computer program product configured to output the modified Z score.

### BRIEF DESCRIPTION OF THE DRAWINGS

FIG. 1 represents a method of obtaining a weighted Z score according to the present invention; and

FIG. 2 illustrates a non-limiting example of a computer that may be used to perform the methods or as a part of the system of the present invention.

### DESCRIPTION OF THE EMBODIMENTS

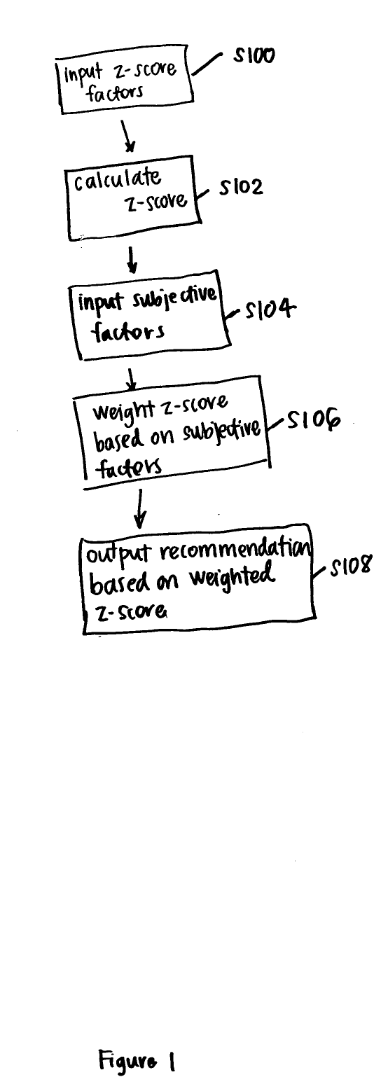

With reference to FIG. 1, the method of the present invention begins with Step S100, where Z score factors are input. Generally, the Z score expresses divergence of an experimental result from the most probable result as a function of the number of standard deviations. As a general rule, the larger the value of Z, the less probable the experimental result is due to chance.

Additionally, Z scores are an application of the rules of transformation. An item's Z score indicates a direction and distance of the item's deviation from the mean of the distribution. The Z score is generally expressed in units of the distribution's standard deviation. If every item in a distribution is converted to a Z score, the transformed Z scores will necessarily have a mean of zero and a standard deviation of 1.

Z scores are also referred to as standard scores. The Z score is useful when seeking to compare the relative standings of items from distributions with different means and/or different standard deviations.

When the distribution of the items is normal, Z scores are very useful. In every normal distribution, a distance between the mean and a Z score divides a fixed proportion of the total area under the curve.

A normal distribution approximates the distribution of values of a characteristic. The normal distribution is useful to model many types of information. The exact shape of a normal distribution depends on the mean and standard deviation of that distribution. The standard deviation measures the spread and indicates the amount of departure of each value from the mean.

Differences in standard deviation model the shape of the distribution. Although the distribution remains symmetric, the normal distribution becomes flatter as the standard deviation increases. With a large standard deviation, there is great diversity between individual items in the normal distribution. Generally, changes in standard deviation do not affect the mean, and changes in the mean do not affect standard deviation.

One Z score that may be used is the Altman Z score. In the early 1960s, the Altman Z score was developed. The Altman Z score relies upon statistical techniques to predict a company's probability of failure using eight variables from a company's financial statements. These factors include earnings before interest and taxes, total assets, net sales, market value of equity, total liabilities, current assets, current liabilities, and retained earnings. These factors are weighted relative to their particular importance under the Altman method. These results are then added together to obtain a Z score value. The Altman Z score is a measurement of the financial health of a company and a powerful diagnostic tool for forecasting a probability that a company may enter bankruptcy within a 12-18 month period. Most studies measuring the effectiveness of disease score technique have shown that the model is accurate in predicting bankruptcy more than 80% of the time. Investors often use the Altman Z score to determine whether or not a company is a reliable investment.

The Altman Z score, as well as other Z score techniques, are also applicable to intellectual property assets. Specifically, it is possible to apply the Altman Z score factors to patent assets. However, simply calculating the Z score from the patent asset may not be enough to determine if the patent asset is worth an investment. Thus, the present invention remedies this deficiency by accounting for objective and subjective factors. The objective factors may include industry size, relative product sales, the number of competitors in this particular technology field, the market value of the owner, forward citations in the United States Patent Office (USPTO) database, the number of patents in the same patent family, the number of claims, the number of oppositions to the patent, the number of independent claims, the number of backward citations, the number of reexaminations, and the age of the technology patented. Subjective factors may also include the potential importance of the technology in an industry and other input from a population of surveyed experts in a relevant field of technology.

By incorporating these objective and subjective factors in the Z score calculation, it may be possible to obtain a more accurate representation of the potential patent asset's values. Additionally, the objective and subjective factors may be accorded different weights in the Z score calculation. These different weights may reflect the relative importance of each factor. On a scale of 1-10, 10 being the most important, some non-limiting weighting examples may include relative product sales being given a weighting coefficient of 7. The industry size may be weighted, for example, as a 6. The age of the technology may have a weight of 5, for example, and the number of competitors may be given a weight of 2.

Alternatively, highly relevant objective factors such as the patent age, the market value of the owner, the forward citations in the USPTO database, the number of patents in the same patent family, the number of claims, and the number of oppositions may be weighted equally. Other relevant objective factors may be given half the weight of the highly objective relevant factors. These relevant (but not highly relevant) objective factors include the number of independent claims, the number of backward citations, and the number of reexaminations. The subjective factors including survey results of experts in the field and the relative importance of the technology in the field may be given twice the weight of the highly relevant objective factors.

To this end, as illustrated in FIG. 1, after the Z score is calculated in step S102, subjective factors (such as those enumerated above), are input in step S104. The Z score is then weighted based on the subjective factors input in step S106. Finally, in step S108, a recommendation is output based on the weighted Z score. Other weightings may be determined using automated or learning systems (e.g., neural networks) so that the system of the present invention learns weightings from a series of desired results (e.g., desired scores or relative rankings).

This invention conveniently may be implemented using a conventional general purpose computer or microprocessor programmed according to the teachings of the present invention, as will be apparent to those skilled in the computer art. Appropriate software can readily be prepared by programmers of ordinary skill based on the teachings of the present disclosure, as will be apparent to those skilled in the software art. Specifically, all of the equations may be implemented by suitably selected computer hardware and software.

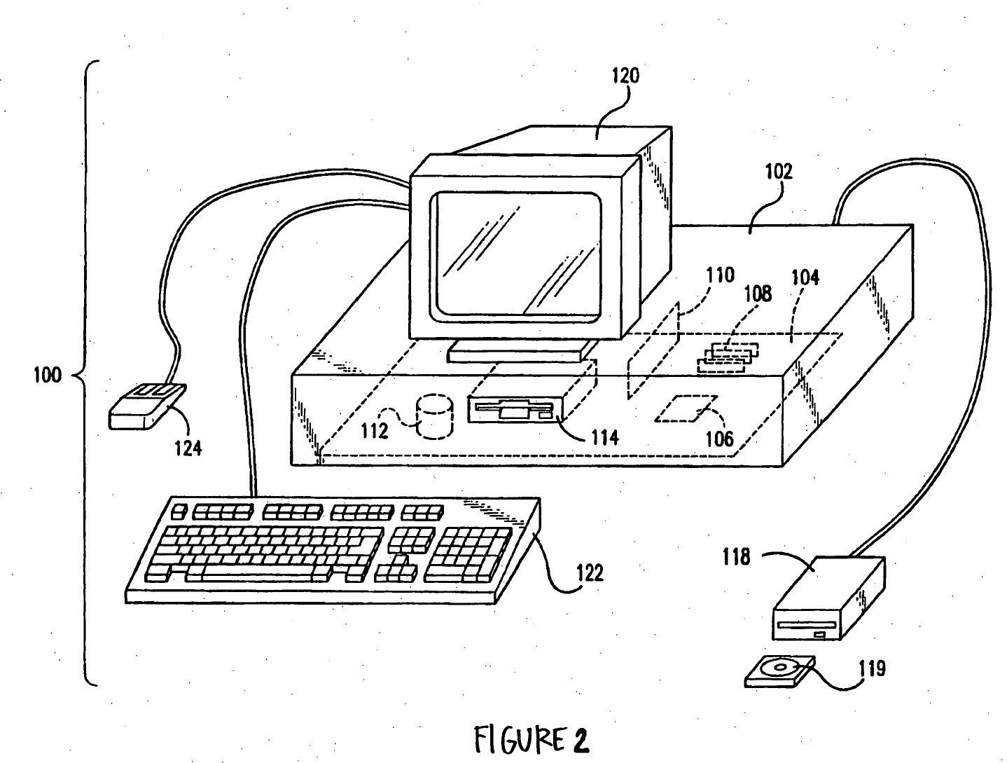

As illustrated in FIG. 2, a computer may implement the method of the present invention, wherein the computer houses a motherboard which contains a CPU, memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

As stated above, the system includes at least one computer readable medium. Examples of computer readable media are compact discs, hard disks, floppy disks, tape, magneto optical disks, PROMS (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools. Computer program products of the present invention include any computer programmed to perform the method of the invention as well as any computer readable medium which stores computer instructions (e.g., computer code devices) which when executed by a computer cause the computer to perform the method of the present invention. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost. For example, processing in regard to the first function may be performed on a first computer and processing in regard to the second function may be performed on a second computer and the results combined.

The invention may also be implemented by the preparation of application specific integrated circuits (ASICs) or by interconnecting an appropriate network of conventional component circuits, as will be readily apparent to those skilled in the art.

Obviously, numerous modifications and variations of the present invention are possible in light of the above teachings. It is therefore to be understood that within the scope of the appended claims, the invention may be practiced otherwise than as specifically described herein.

What is claimed is:

1. A method for determining a relative value of at least one patent, the method comprising:
calculating a Z score for the at least one patent; and
modifying the Z score based on at least one subjective factor.

2. The method according to claim 1, wherein the calculating step includes calculating the Z-score based on at least one objective factor.

3. The method according to claim 2, wherein the at least one objective factor includes at least one of industry size, relative product sales, a number of competitors in a technology field, a market value of an owner, a number of forward citations in a United States Patent Office (USPTO) database, a number of patents related to the at least one patent, a number of claims, a number of oppositions to the at least one patent, a number of independent claims, a number of backward citations, a number of reexaminations, and an age of a technology claimed in the at least one patent.

4. The method according to claim 1, wherein the at least one subjective factor is weighted.

5. The method according to claim 1, wherein the at least one subjective factor includes at least one of at least one expert opinion and an importance of the technology.

6. The method according to claim 1, further comprising selecting the at least one patent based on an output of the modifying step.

7. A system for determining a relative value of at least one patent, the system comprising:
a database configured to store at least one factor for calculating a Z score for the at least one patent;
a database for storing at least one received subjective factor relevant to the at least one patent;
a first computer program product configured to calculate a Z score based on the at least one factor;
a second computer program product configured to modify the Z score based on the at least one subjective factor, thereby obtaining a modified Z score; and
a third computer program product configured to output the modified Z score.

8. The method according to claim 7, wherein the at least one factor includes at least one objective factor.

9. The method according to claim 8, wherein the at least one objective factor includes at least one of industry size, relative product sales, a number of competitors in a technology field, a market value of an owner, a number of forward citations in a United States Patent Office (USPTO) database, a number of patents related to the at least one patent, a number of claims, a number of oppositions to the at least one patent, a number of independent claims, a number of backward citations, a number of reexaminations, and an age of a technology claimed in the at least one patent.

10. The system according to claim 7, wherein a single computer program product includes the first computer program product, the second computer program product, and the third computer program product.

11. The system according to claim 7, wherein the at least one subjective factor is weighted.

12. The system according to claim 7, wherein the at least one subjective factor includes at least one of at least one expert opinion and an importance of the technology.

13. The system according to claim 7, further comprising a fourth computer program product configured to select the at least one patent based on the modified Z score.

14. The system according to claim 13, wherein a single computer program product includes the first computer program product, the second computer program product, the third computer program product, and the fourth computer program product.
